(19) United States
(12) Patent Application Publication
(10) Pub. No.: US 2005/0128164 A1
(43) Pub. Date: Jun. 16, 2005

(54) Video driving module for multiple monitors and method for the same

(76) Inventor: Jet Lan, Hsin Tien City (TW)

Correspondence Address: BIRCH STEWART KOLASCH & BIRCH, PO BOX 747, FALLS CHURCH, VA, 22040-0747, US

(21) Appl. No.: 10/735,904

(22) Filed: Dec. 16, 2003

(51) Int. Cl. G09G 5/00

(52) U.S. Cl. 345/1.1

(57) ABSTRACT

A video driving module for multiple monitors and method for the same are proposed. The video driving module has a CRT controller for converting a plurality of image signal into a plurality of digital video signals, and a plurality of converters connected to output the CRT controller and used for converting the digital video signals into a plurality of RGB analog signals. The output of each converter is connected to a monitor for displaying one of the plurality of RGB analog signals. The multiple monitors can be simultaneously displayed and refreshed.

### FIELD OF THE INVENTION

The present invention relates to a video driving module for monitor and method for the same, and especially to a video driving module for multiple monitors and method for the same.

### BACKGROUND OF THE INVENTION

Nowadays a computer operation system, such as Windows 98/ME/2000/XP, generally has the ability to use multiple monitors on one system. The system with multiple monitors can be advantageously used in an airport or train station to post schedules or in a stock market for a TV wall.

FIG. 1 shows a computer connected externally to a plurality of monitors in a prior art multiple monitor system. The motherboard of the computer 1 generally has a plurality of expansion slots such as PCI slots or ISA slots to allow for upgrades. To render the computer capable of using multiple monitors, the operation system of the computer should have an associated ability to drive multiple monitors. Moreover, a plurality of video adaptor cards 12 is installed in the slots of the motherboard and each of the video adaptor cards is connected to a monitor 2. The operation system sends corresponding video signals through a chipset 11 on the motherboard to each of video adaptor cards 12 through a bus. The video signal will be displayed on corresponding monitor.

FIG. 2 shows a computer connected externally to a plurality of monitors in another prior art multiple monitor system. The number of accessible monitors in FIG. 1 is limited by the number of slots in the motherboard. If the motherboard of a computer has 4-6 slots, the computer can only control 4-6 monitors. In the multiple monitor system shown in FIG. 2, the shortage is improved by providing a plurality of bus bridges 13 between the chipset 11 and the video adaptor cards 12. Each of the bus bridges 13 can be connected to, for example, four video cards 12 and about 4-6 bus bridges 13 can be arranged on the motherboard. In other words, the computer according to FIG. 2 can control up to 16-24 monitors through only one motherboard.

FIG. 3 shows the schematic view of a prior art video driving module 14 for display. The video driving module 14 is referred to as a video adaptor card inserted in a slot or a display chipset on the motherboard. The display chipset 14 has an interface unit 144 for receiving video data from a chipset, and a video memory 141 for storing the video data, a graphics engine 143 to provide a graphic acceleration function for reducing the load on the CPU, and a CRT controller 142 for processing the color of each pixel in the video data and generate a digital video signal to a digital to analog converter (DAC) 145. The DAC 145 converts the digital video signal into a RGB analog signal and sends the RGB analog signal to a monitor 2. Moreover, the CRT controller 142 sends vertical/horizontal sync signals to the monitor 2. In FIG. 3, the CRT controller 142 is set to operate in a true color mode to encode each pixel by 24 bits.

The video driving module 14 shown FIG. 3 is used for a conventional monitor. The video driving module 14 can only be connected to one monitor 2. For a computer, the number of monitors accessible is doubled by doubling the CRT controller 142 and the DAC 145. The architecture is shown in FIG. 4, in which the video driving module 14 has a first CRT controller 142a and a second CRT controller 142b. If the techniques illustrated in FIG. 2 and FIG. 4 are simultaneously used in a system, the system can access up to 32-48 monitors.

The system with ability to use multiple monitors can adopt the architecture as shown in FIGS. 1, 2, and 4. However, the operation system of the computer must initialize each video driving module 14 to refresh each monitor 2. The reason is that the I/O ports of the video driving modules 14 and the addresses of the video memory 141 are identical for the chipset on motherboard.

FIG. 5 is a flowchart of describing the refreshing step of a video driving module with the assumption that i=1 at beginning and the refreshing number of monitor is 48. In a first step 51, the access interface of video driving module 1 is opened. Then in step 52, the video memory of video driving module 1 is refreshed. Afterward, in step 53, the access interface of video driving module 1 is closed. Step 54 checks whether all video driving module are refreshed. If yes, the refreshing operation is finished, if not, i is added to 1 in step 55 and the procedure returns to step 51. The total refreshing time is 24 sec if the refreshing time for one monitor is 0.5 sec.

The above mentioned prior art scheme for achieving multiple monitors has the following problems. A system with the architecture shown in FIG. 1 is limited by the number of slots. A system with the architecture shown in FIG. 2 is limited by the number of bus bridges 13 and the size of the motherboard. Moreover, the provision of the bus bridges also increases cost. A system with the architecture shown in FIG. 4 has the problem of complicated circuits and a higher cost than that of FIG. 3, even thought two monitors 2 are driven by one video driving module. Moreover, the system with the architecture shown in FIG. 4 can only refresh the monitors one by one, and cannot refresh all monitors simultaneously. The monitor is not refreshed until the corresponding path of the video driving module 14 is opened. The total refreshing time is considerable if the number of the monitors is large.

### SUMMARY OF THE INVENTION

It is an object of the present invention to provide a video driving module for multiple monitors and a method for the same, wherein a single video driving module is used to drive multiple monitors.

It is another object of the present invention to provide a video driving module for multiple monitors and a method for the same, wherein a single video driving module is used to refresh multiple monitors.

To achieve the above objects, the present invention provides a video driving module for multiple monitors, which comprises a CRT controller, and a plurality of converters. The CRT controller generates an image signal and the image signal is divided into a plurality of equal parts, each of the parts being associated to one of the digital-to-analog converters.

To achieve the above objects, the present invention provides a motherboard for multiple monitors, which motherboard comprises a chipset for outputting a plurality of image signals, a CRT controller converting the plurality of image signals to a plurality of video signals, and a plurality of converters converting the video signals to signals adapted for the monitors and outputting the signals to monitors.

To achieve the above objects, the present invention provides a method for driving multiple monitors, a plurality of monitors being driven by a CRT controller and a plurality of converters, the method comprising following steps: the CRT controller processes a plurality of image signals into a plurality of video signals; the plurality of video signals is sent to the plurality of converters for converting the video signals into signals adapted for the monitors; and the signals adapted for the monitors are sent to the monitors.

### BRIEF DESCRIPTION OF DRAWING

The various objects and advantages of the present invention will be more readily understood from the following detailed description when read in conjunction with the appended drawing, in which:

FIG. 1 shows a computer connected externally to a plurality of monitors in a prior art multiple monitor system;

FIG. 2 shows a computer connected externally to a plurality of monitors in another prior art multiple monitor system;

FIG. 3 shows the schematic view of a prior art video driving module for display;

FIG. 4 shows a schematic diagram of a video driving module for two monitors;

FIG. 5 is a flowchart of refreshing step of video driving module;

FIG. 6 shows a schematic diagram of a video driving module according to the present invention; and FIG. 7 demonstrates a video signal being output to a plurality of monitors according to the present invention.

### DETAILED DESCRIPTION OF THE INVENTION

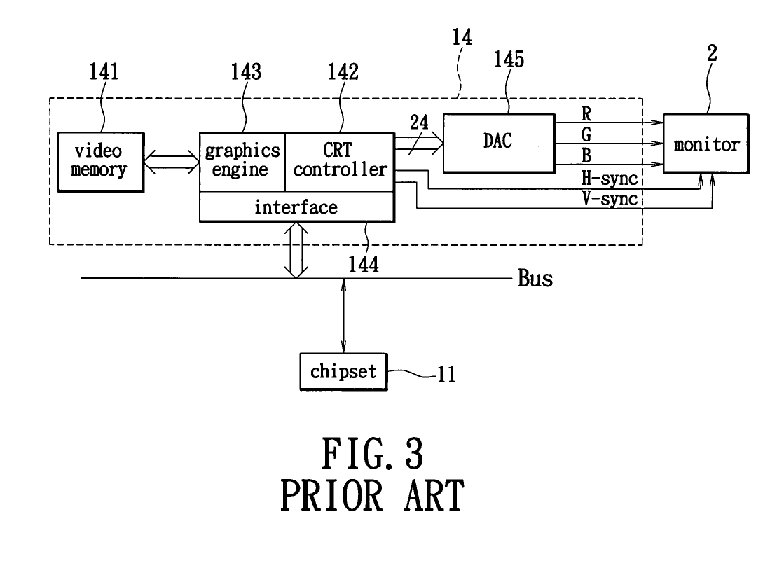

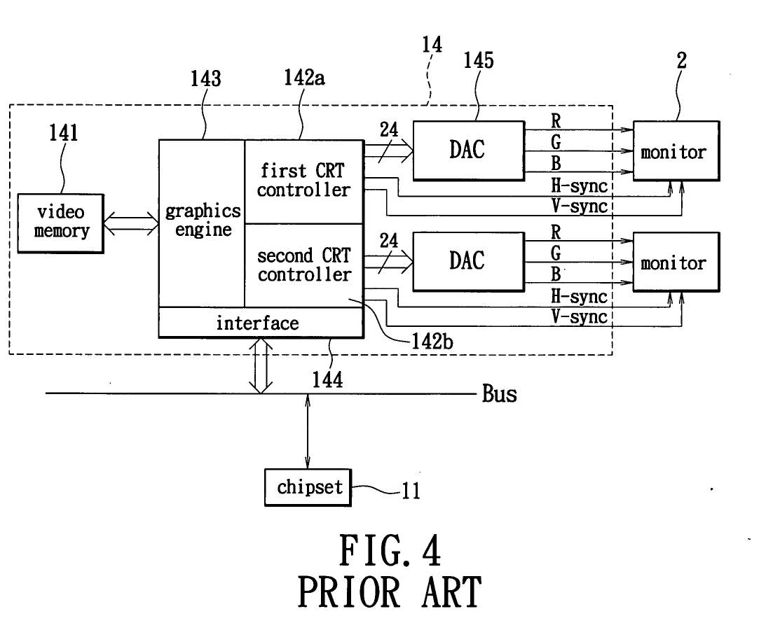

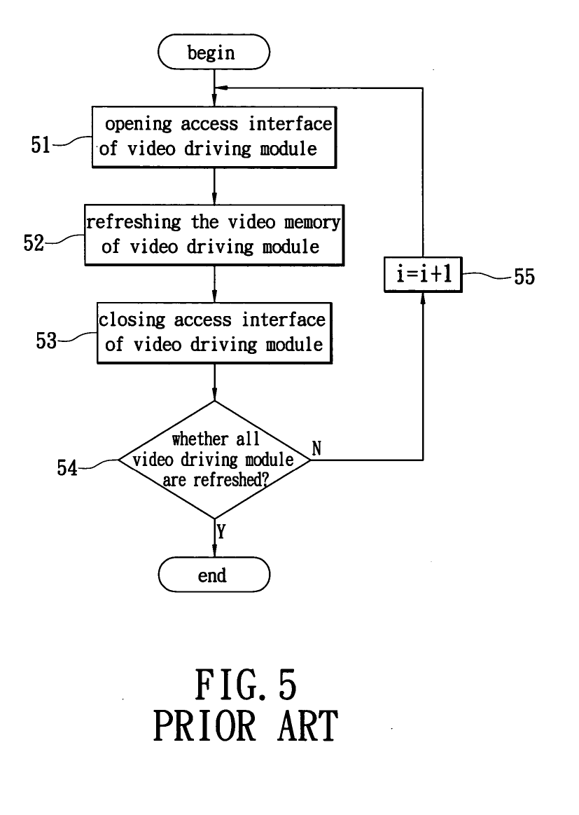

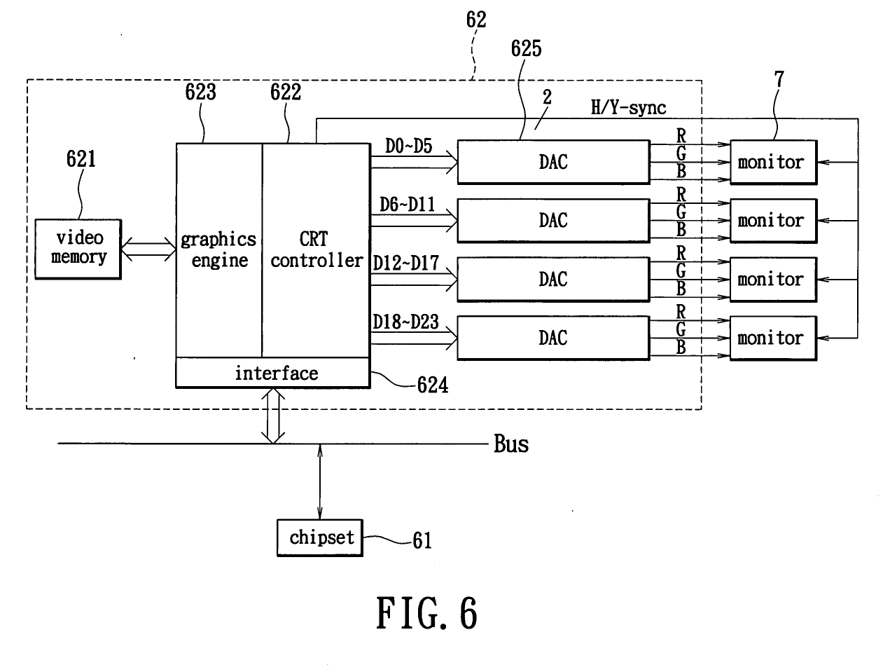

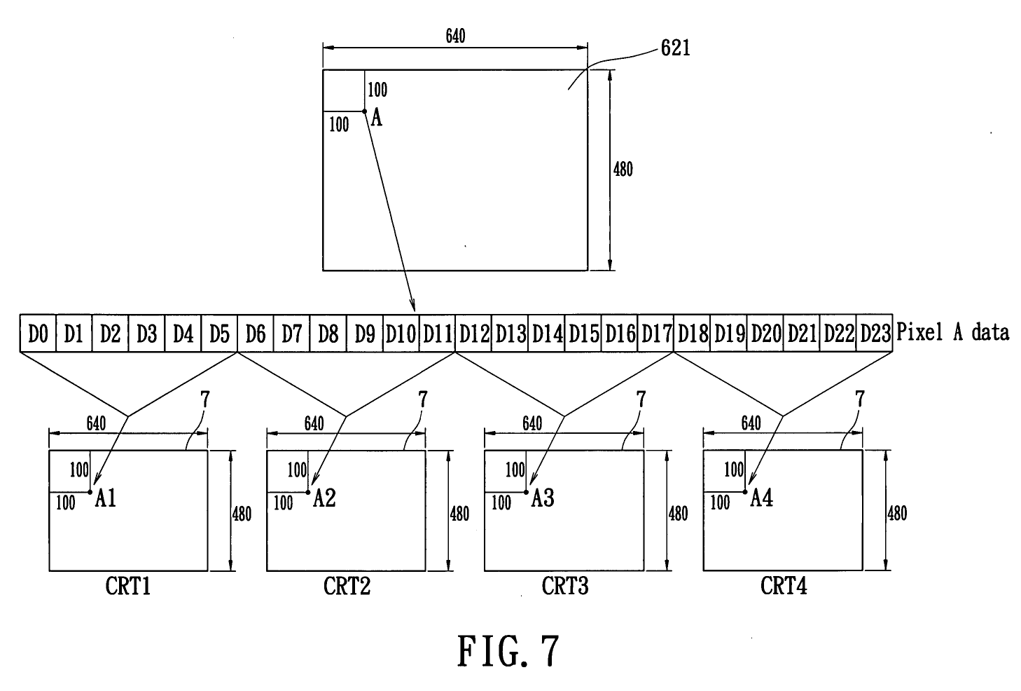

FIG. 6 shows a schematic diagram of a video driving module 62 according to the present invention. The video driving module 62 comprises a video memory 621, a CRT controller 622 and a plurality of DAC 625. The operation of each component is similar to that in FIG. 3 and the description thereof is omitted here. The present invention is characterized by the output of the CRT controller 622 being connected to a plurality of DAC 625, which is different from the illustrations of FIGS. 3 and 4, wherein the output of the CRT controller 142a is connected to only one DAC 145.

For many applications of multiple-monitor systems such as posting a schedule in a train station or airport, the display color does not exceed 256 colors. More particularly, 2-4 colors are sufficient. For even colorful applications such as an indicator in a stock market, 20 colors suffice. Full color output such as the case shown in FIG. 3 is not practical for those applications.

In the present embodiment, the digital video signal output by the CRT controller 622 is divided into a plurality of equal parts corresponding to the number of the monitors 7. The video driving module 62 has DAC 625 with a number corresponding to the monitors 7. The color number displayed by the monitor 7 depends on the bit number of each partition.

For example, if the digital video signal output by the CRT controller 622 has 24 bits for each pixel, the CRT controller 622 will divide the 24 bit data into four parts. Each of the parts has 6-bit color representation for defining a new digital video signal. The CRT controller 622 is connected to 4 DAC 625, and each DAC 625 is connected to a monitor 7. Therefore, each monitor 7 can display 64 colors. The CRT controller 622 simultaneously sends a vertical/horizontal sync signal to each monitor 7 and simultaneously sends four sets of digital video signals to the four monitors 7. Therefore, all monitors can be simultaneously displayed and refreshed.

When four image screens are simultaneously display to synthesize a virtual desktop, four sets of video signals are output from a chipset 61. The four sets of video signals are sent through a bus and then sent to the video memory 621 through an interface 624. The graphics engine 623 provides a graphic acceleration function for the video signals. The CRT controller 622 processes the color of each pixel in the video signals to generate four digital video signals to corresponding DAC 625. The DAC 625 converts the digital video signal into RGB analog signal and sends the RGB analog signal to a monitor 7.

FIG. 7 demonstrates a video signal output to a plurality of monitors. In this example, each monitor 7 has resolution of 640×480 and a pixel A in the 100^{th} row and the 100^{th} column of the video memory 621 is used as an example. The video signal in pixel A is processed by the CRT controller 622 and converted into a digital video signal with bits D0-D23. The bits D0-D5 of the pixel A are output to pixel A1 of CRT 1 in the 100^{th} row and the 100^{th} column. The bits D6-D11 of the pixel A are output to pixel A2 of CRT 2 in the 100^{th} row and the 100^{th} column. The bits D12-D17 of the pixel A are output to pixel A3 of CRT 3 in the 100^{th} row and the 100^{th} column. The bits D18-D23 of the pixel A are output to pixel A4 of CRT 4 in the 100^{th} row and the 100^{th} column. In other words, the data bits for one pixel of the video memory 621 can be mapped to a plurality of image data in a plurality of monitors.

To sum up, the video driving module 62 according to the present invention is connected to a plurality of DAC 625 through the output of the CRT controller 622, thus controlling a plurality of monitors 7 by only one video driving module 62. Moreover, the plurality of digital video signals output from the CRT controller 622 share the same graphics engine 623 and the same video memory 621. An application program can simultaneously refresh all monitors.

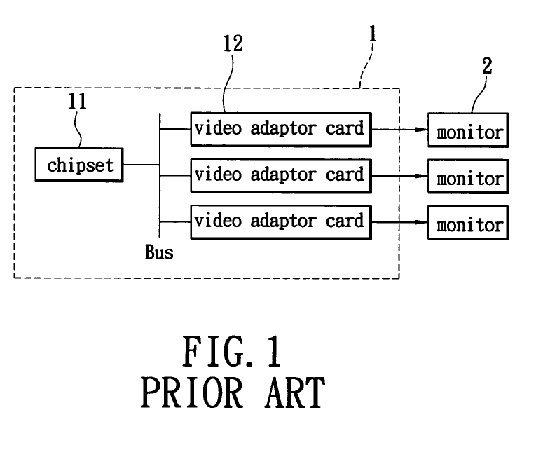

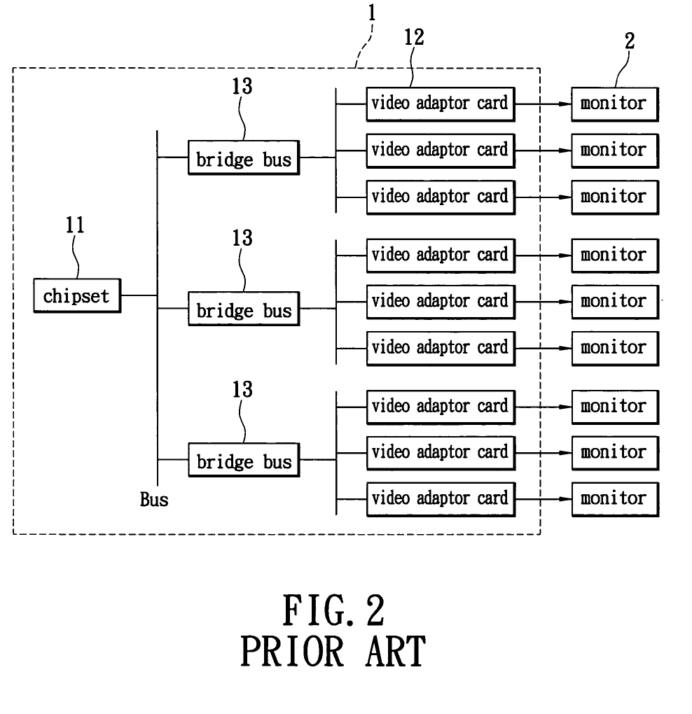

The video driving module 62 according to the present invention can be implemented on a video adaptor card or directly on a motherboard. In the former case, the video driving module 62 is inserted into a slot as shown in FIG. 1. Moreover, a plurality of bus bridges 13 can be arranged on a motherboard to increase the slot number and drive more monitors.

The video driving module according to the present invention has the following advantages:

(1) driving a plurality of monitors with a single video driving module;

(2) simultaneously refreshing a plurality of monitors with a single video driving module; and

(3) flexibly adjusting the number of accessible monitors by adjusting the display color.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A video driving module for multiple monitors, comprising:
a CRT controller; and
a plurality of converters;
wherein the CRT controller generates a video signal and the video signal is divided into a plurality of equal parts, each of the parts being associated with one of the converters.

2. The video driving module as in claim 1, wherein the CRT controller converts a plurality of parts of the image signal into the plurality of video signals.

3. The video driving module as in claim 2, further comprising a video memory to store the image signal.

4. The video driving module as in claim 1, wherein each of the video signals is a digital signal.

5. The video driving module as in claim 1, wherein the CRT controller has a graphics engine.

6. The video driving module as in claim 1, wherein the CRT controller generates a vertical/horizontal sync signal to the monitors.

7. The video driving module as in claim 1, wherein the converter is a digital-to-analog converter (DAC).

8. A motherboard for multiple monitors, comprising:
a chipset for outputting a plurality of image signals;
a CRT controller for converting the plurality of image signals into a plurality of video signals; and
a plurality of converters for converting the video signals into signals adapted for the monitors and outputting the signals to monitors.

9. The motherboard as in claim 8, wherein the CRT controller generates a vertical/horizontal synchronization signal to the monitors.

10. The motherboard as in claim 8, wherein the converter is a digital-to-analog converter (DAC).

11. The motherboard as in claim 8, further comprising a video memory to store the image signal.

12. A method for driving multiple monitors, a plurality of monitors being driven by a CRT controller and a plurality of converters, the method comprising following steps:
the CRT controller processing a plurality of image signals into a plurality of video signals;
sending the plurality of video signals to the plurality of converters for converting the video signals into signals adapted for the monitors; and
sending the signals adapted for the monitors to the monitors.

13. The method for driving multiple monitors as in claim 12, further comprising a step of storing the image signals in a video memory.

14. The method for driving multiple monitors as in claim 12, wherein the converters convert the video signals into RGB analog signals.

15. The method for driving multiple monitors as in claim 12, wherein the CRT controller generates a vertical/horizontal synchronization signal to the monitors.
